(19) United States
(12) Patent Application Publication
(10) Pub. No.: US 2009/0024616 A1
(43) Pub. Date: Jan. 22, 2009

(54) CONTENT RETRIEVING DEVICE AND RETRIEVING METHOD

(76) Inventors: Yosuke Ohashi, Saitama-ken (JP); Yoichi Hara, Tokyo (JP)

Correspondence Address: BIRCH STEWART KOLASCH & BIRCH, PO BOX 747, FALLS CHURCH, VA, 22040-0747, US

(21) Appl. No.: 12/172,751

(22) Filed: Jul. 14, 2008

(30) Foreign Application Priority Data
Jul. 19, 2007 (JP) 2007-188797

(51) Int. Cl. G06F 7/06; G06F 17/30

(52) U.S. Cl. 707/5; 707/E17.014

(57) ABSTRACT

A content retrieving device has: a content storing unit in which are stored a plurality of contents that are associated with one or more character strings; a thesaurus storing unit in which is stored a thesaurus that includes vertical relationship information between character strings; an inputting unit by which a character string is inputted; an extracting unit extracting an associated character string that is associated with an inputted character string, by using the thesaurus and on the basis of association degree information that expresses association degrees between character strings included in the thesaurus by numerical values determined in accordance with the vertical relationship information=between the character strings; and a retrieving unit retrieving contents associated with the associated character string and the inputted character string.

### CROSS-REFERENCE TO RELATED APPLICATIONS

This application claims priority under 35 USC 119 from Japanese Patent Application No. 2007-188797, the disclosure of which is incorporated by reference herein.

### BACKGROUND OF THE INVENTION

1. Field of the Invention

The present invention relates to retrieving contents, and in particular, to a content retrieving device and retrieving method that retrieve contents associated with an inputted character string.

2. Description of the Related Art

Techniques for efficiently retrieving a large amount of digital contents have been widely developed in recent years owing to the evolution of digital technology.

In relation to such technology, Japanese Patent Application Laid-Open (JP-A) No. 2005-348071 discloses a device that generates television broadcast programs or the like. The device retrieves contents that include an inputted keyword or an associated keyword that is associated with that keyword, and outputs the contents together with the priority level thereof.

Further, JP-A No. 9-120401 discloses a method in which semantic distances between words, that are based on coocurrence data and frequency of appearance, are computed for words that are morphologically analyzed on the basis of a large amount of sentences. A thesaurus is constructed by hierarchically arranging groups that are formed on the basis of the distances.

“Thesaurus Construction from Large-Scale Web Dictionaries” by Kotaro Nakayama, Takahiro Hara and Shojiro Nishio, DBSJ Letters, Vol. 5, No. 4, pp. 41-44, 2007 discloses a method of constructing a thesaurus by mining a large-scale web dictionary such as Wikipedia or the like, and proposes, as a method of calculating degrees of association between words, an algorithm that limits the search distance and calculates an approximate solution.

In the technique disclosed in aforementioned JP-A No. 2005-348071, contents are retrieved by using not only an inputted keyword but also an associated keyword. How to construct a dictionary or a thesaurus for acquiring associated keywords is essential, but the point of how to construct a dictionary or a thesaurus for acquiring associated keywords is not disclosed in JP-A No. 2005-348071.

Further, in the technique disclosed in aforementioned JP-A No. 9-120401, there is a problem to be solved in the point that a sufficient amount of sentence data must be prepared at the time of constructing a thesaurus. Moreover, in this technique, a hierarchical structure is generated mechanically merely by the establishment of formal coocurrences.

In this way, the conventional techniques have the problem that a wide range of contents cannot be retrieved because keywords that are character strings are not sufficiently prepared.

Further, in the technique disclosed in the aforementioned document “Thesaurus Construction from Large-Scale Web Dictionaries”, at the time of calculating the strength of the association between descriptions, complex matrix computation, in which the number of line elements and the number of row elements is the total number of descriptions, is required. There is the problem that huge-scale computation must be carried out when constructing the thesaurus.

### SUMMARY OF THE INVENTION

In view of the above-described drawbacks, the present invention provides a content retrieving device and retrieving method in which a wide range of contents associated with a character string can be retrieved by using a thesaurus.

In order to achieve the above object, a first aspect of the present invention is a content retrieving device including: a content storing unit in which are stored a plurality of contents that are associated with one or more character strings; a thesaurus storing unit in which is stored a thesaurus that includes vertical relationship information expressing vertical relationships between character strings that are determined on the basis of meanings of the character strings; an inputting unit by which a character string is inputted; an extracting unit extracting an associated character string that is associated with an inputted character string inputted by the inputting unit, by using the thesaurus stored by the thesaurus storing unit and on the basis of association degree information that expresses association degrees between character strings included in the thesaurus by numerical values determined in accordance with the vertical relationship information expressing vertical relationships between the character strings; and a retrieving unit retrieving, from contents that are stored by the content storing unit, contents associated with the associated character string extracted by the extracting unit and the inputted character string.

In accordance with the first aspect of the present invention, plural contents that are associated with one or more character strings are stored in the content storing unit. A thesaurus, that includes vertical relationship information expressing vertical relationships between character strings that are determined on the basis of the meanings of the character strings, is stored in the thesaurus storing unit. A character string is inputted by the inputting unit. The extracting unit extracts an associated character string that is associated with the inputted character string inputted by the inputting unit, by using the thesaurus stored by the thesaurus storing unit and on the basis of association degree information that expresses association degrees between character strings included in the thesaurus, by numerical values determined in accordance with the vertical relationship information expressing the vertical relationships between the character strings. The retrieving unit retrieves, from contents that are stored in the content storing unit, contents associated with the associated character string extracted by the extracting unit and the inputted character string. In this way, there can be provided a content retrieving device that can retrieve a wide range of contents associated with a character string, by extracting an associated character string on the basis of association degree information that is expressed by numerical values determined in accordance with vertical relationship information.

The content retrieving device of the first aspect of the present invention may be structured so as to further include a calculating unit calculating the association degree information on the basis of distances between character strings in the thesaurus, wherein, when the extracting unit extracts the associated character string, the extracting unit extracts an associated character string whose association degree information calculated in advance by the calculating unit is greater than or equal to a predetermined value.

In accordance with the above-described structure, the processing of searching the thesaurus and computing the association degrees each time a search is carried out is eliminated. Therefore, the processing time needed for retrieval can be greatly shortened.

The content retrieving device of the first aspect of the present invention may further include an acquiring unit (acquiring means) acquiring character string information that includes a plurality of character strings and relationship information expressing relationships between character strings of the plurality of character strings; and a thesaurus constructing unit that, on the basis of the character string information acquired by the acquiring unit, automatically reconstructs the thesaurus by reflecting the character string information in the thesaurus. The acquiring unit may be structured to include the above-described inputting unit.

In accordance with the above-described structure, a thesaurus can be reconstructed automatically by reflecting the character string information in the thesaurus. Therefore, the character strings included in the thesaurus can be enriched.

In the content retrieving device of the first aspect of the present invention, the character string information may include belonging category information that includes information, in which the respective character strings of the plurality of character strings and categories to which the character strings belong are made to correspond to one another, and information, in which the categories and categories to which the categories belong are made to correspond to one another.

In accordance with the above-described structure, the character string information can include information, in which the respective character strings of the plural character strings and categories to which the character strings belong are made to correspond to one another, and information, in which the categories and categories to which the categories belong are made to correspond to one another.

In the content retrieving device of the first aspect of the present invention, the thesaurus constructing unit may automatically reconstruct the thesaurus by determining, from the belonging category information, a second character string belonging to a higher-order category which is a category to which belongs a category to which belongs a first character string which is a character string among the plurality of character strings, and making the second character string be a higher-order word of the first character string.

In accordance with the above-described structure, the vertical relationships in the thesaurus can be constructed from the relationships of dependence between the categories.

In the content retrieving device of the first aspect of the present invention, the thesaurus constructing unit may automatically reconstruct the thesaurus by determining, from the belong category information, a third character string that belongs to a lower-order category which is a category that belongs to a category to which the first character string belongs, and making the third character string be a lower-order word of the first character string.

In accordance with the above-described structure, the vertical relationships in the thesaurus can be constructed from the relationships of dependence between the categories.

In the content retrieving device of the first aspect of the present invention, the character string information may further include description information that is information associated with the respective character strings of the plurality of character strings, and association information that, on the basis of description information relating to a fourth character string among the plurality of character strings, associates a fifth character string among the plurality of character strings with the fourth character string, and the thesaurus constructing unit may automatically reconstruct the thesaurus by making the fifth character string, with which the fourth character string is associated in the association information, be a parallel word which is different than both a higher-order word and a lower-order word of the fourth character string.

In accordance with the above-described structure, the thesaurus can be constructed by using, as a parallel word, a character string that is included in the description information relating to a given fourth character string.

The content retrieving device of the first aspect of the present invention may be structured so as to further include a second calculating unit calculating the association degree information on the basis of the thesaurus, wherein, from the belonging category information, the second calculating unit determines a category belonging to a category to which the second character string belongs, and the second calculating unit carries out calculation such that, the greater the number of the categories, the more the association degree information between the first character string and the second character string decreases.

In accordance with the above-described structure, the association degree between a second character string, which has many lower-order words, and the first character string can be made to be low.

The content retrieving device of the first aspect of the present invention may be structured such that, from the belonging category information, the second calculating unit determines a category belonging to a category to which the third character string belongs, and the second calculating unit carries out calculation such that, the greater the number of the categories, the more the association degree information between the first character string and the third character string decreases.

In accordance with the above-described structure, the association degree between a third character string, which has many higher-order words, and the first character string can be made to be low.

The content retrieving device of the first aspect of the present invention may be structured such that, from the association information, the second calculating unit carries out calculation such that, the greater the number of character strings other than the fifth character string that are associated with the fourth character string, the more the association degree information between the fourth character string and the fifth character string decreases.

In accordance with the above-described structure, the greater the number of associated parallel words, the lower the association degree can be made to be.

A second aspect of the present invention is a content retrieving method including: providing a content storing unit in which are stored a plurality of contents that are associated with one or more character strings; providing a thesaurus storing unit in which is stored a thesaurus that includes vertical relationship information expressing vertical relationships between character strings that are determined on the basis of meanings of the character strings; receiving a character string associated with content that is an object of retrieval; extracting an associated character string that is associated with the character string, by using the thesaurus stored by the thesaurus storing unit and on the basis of association degree information that expresses association degrees between character strings included in the thesaurus by numerical values determined in accordance with the vertical relationship information expressing vertical relationships between the character strings; and retrieving, from contents that are stored by the content storing unit, contents associated with the extracted associated character string and the inputted character string.

### BRIEF DESCRIPTION OF THE DRAWINGS

FIG. 1 is a drawing showing the structure of a personal computer (a content retrieving device);

FIGS. 2A and 2B are drawings showing examples of a content table and a keyword table;

FIG. 3 is a drawing showing an example of a thesaurus;

FIG. 4 is a drawing showing an association degree table;

FIG. 5 is a flowchart showing content retrieving processing;

FIG. 6 is a flowchart showing association degree calculating processing;

FIG. 7 is a drawing showing an example of dictionary data;

FIG. 8 is a drawing showing another example of dictionary data;

FIG. 9 is a flowchart showing thesaurus reconstructing processing (a first method);

FIGS. 10A, 10B and 10C are drawings showing various types of tables;

FIG. 11 is a drawing showing an association table;

FIG. 12 is a drawing showing an association degree table;

FIG. 13 is a flowchart showing thesaurus reconstructing processing (a second method);

FIG. 14 is a flowchart showing higher-order word extracting processing;

FIG. 15 is a flowchart showing lower-order word extracting processing;

FIG. 16 is a flowchart showing parallel word extracting processing; and

FIG. 17 is a flowchart showing association degree calculating processing.

### DETAILED DESCRIPTION OF THE INVENTION

An exemplary embodiment of the present invention will be described in detail hereinafter with reference to the drawings. Note that, in the present exemplary embodiment, a case in which a content retrieving device is realized by a personal computer is described as an example. Further, in the following description, a character string is expressed as a keyword.

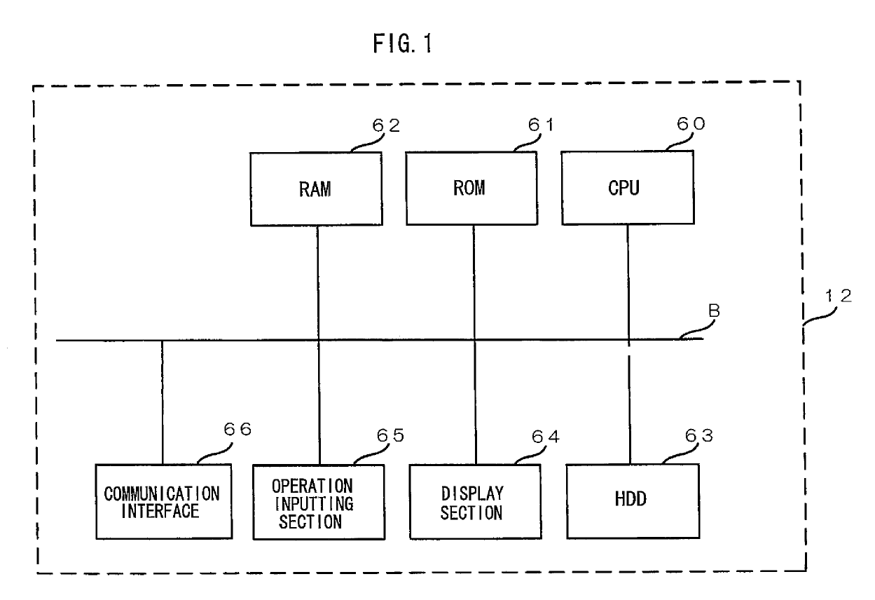

First, the structure of a personal computer 12 will be described by using FIG. 1. The personal computer 12 includes a CPU (Central Processing Unit) 60, a ROM (Read Only Memory) 61, a RAM (Random Access Memory) 62, an HDD (Hard Disk Drive) 63, a display section 64, an operation inputting section 65 and a communication interface 66, that are respectively connected by a bus B.

The CPU 60 governs the overall operation of the personal computer 12. Programs that will be described later are executed by the CPU 60. The ROM 61 is a nonvolatile storage device that stores a boot program, that operates at the time of start-up of the personal computer 12, and the like. The RAM 62 is a volatile storage device in which an OS (Operating System), programs, and data are loaded. The HDD 63 is a nonvolatile storage device that stores a content table, a keyword table, a thesaurus, an association degree table, the OS, programs and the like that will be described later. The HDD 63 corresponds to a content storing unit and a thesaurus storing unit.

The display section 64 displays various types of predetermined information such as retrieved contents and the like. The operation inputting section 65 is used in cases in which a user operates the personal computer 12, and at times when a user inputs information such as a keyword or the like to the personal computer 12. The communication interface 66 is an interface for communicating with external devices such as other personal computers and the like, and is an NTC (Network Interface Card) for carrying out communication, a USB device, or the like.

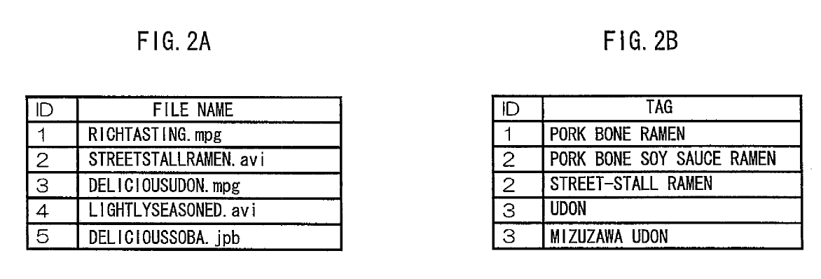

The aforementioned content table and keyword table will be described next by using FIG. 2A and FIG. 2B. FIG. 2A shows a content table, and FIG. 2B shows a keyword table.

The content table is a table that stores information relating to contents that are the object of retrieval. As shown in FIG. 2A, the content table is structured so as to include IDs and file names. Thereamong, the ID is a character string, a numerical value or the like for uniquely specifying a content. The file name is a file name or path or the like where the content is actually located. Note that, rather than being handled as files, the contents may be directly stored in a database.

The keyword table shown in FIG. 2B is a table that stores keywords that the contents which are stored in the content table are associated with. As shown in FIG. 2B, the keyword table is structured to include IDs and tags. Thereamong, the ID is a character string, a numerical value or the like for uniquely specifying the aforementioned content, and corresponds to the ID of the content table. Further, a keyword that is associated with the content corresponding to the ID is stored in the tag. For example, the keyword that is associated with the ID 1 and the file name “richtasting.mpg” in the content table of FIG. 2A is pork bone ramen shown by the tag with the ID of 1 in FIG. 2B.

In this way, plural contents that are associated with one or more keywords are stored in the HDD 63.

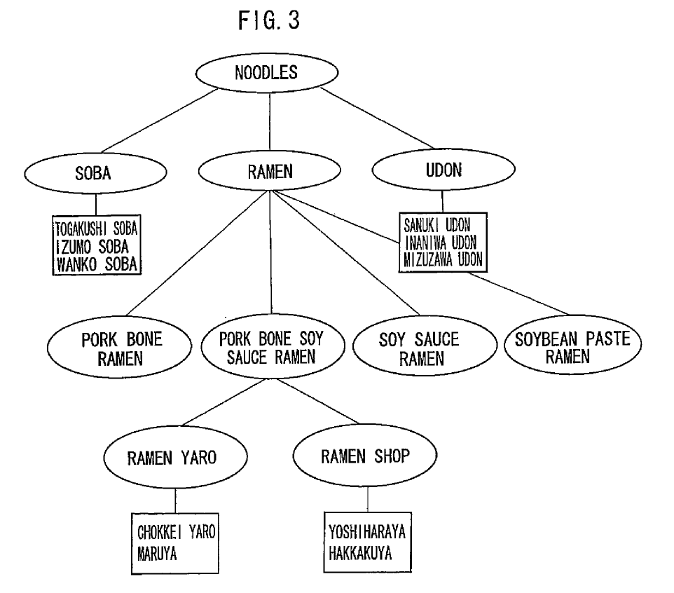

Next, an example of a thesaurus will be described by using FIG. 3. A thesaurus is a so-called “synonym dictionary” in which associations among words are drawn. As shown in FIG. 3, a thesaurus includes respective keywords, and information expressing the higher-order/lower-order/parallel relationships among the respective keywords. In FIG. 3, for example, the higher order of ramen is noodles, and a lower order of ramen is pork bone ramen. Parallel to ramen are soba (buckwheat noodles) and the like.

In this way, the thesaurus in the present exemplary embodiment includes information that shows the vertical relationships among keywords that are determined on the basis of the meanings of the keywords.

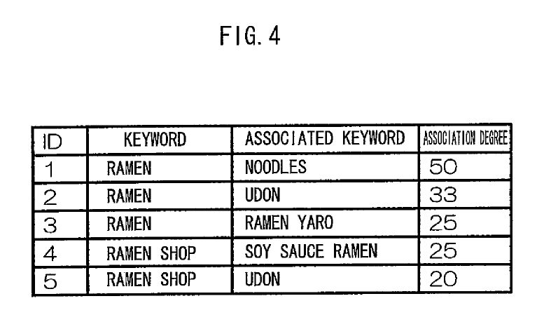

The aforementioned association degree table will be described next by using FIG. 4. The association degree table is a table that stores the association degrees and the like at the time of calculating association degrees between keywords in advance.

As shown in FIG. 4, the association degree table is structured to include IDs, keywords, associated keywords, and association degrees (association degree information).

Thereamong, the ID is a character string, a numerical value or the like for uniquely specifying a combination of a keyword and a keyword that is called an associated keyword. The keyword and the associated keyword express a pair of two keywords for showing a degree of association. Note that the keywords and the associated keywords may be keywords themselves as shown in FIG. 4, or the IDs of the keyword table shown in FIG. 2A may be used.

The association degree is a numerical value expressing how much of an association there is between the two keywords that form the pair. The higher this value, the greater the association the keywords can be considered to have. The method of calculating the association degree will be described later.

Next, processings executed by the CPU 60 by using the above-described tables and thesaurus will be described by using flowcharts.

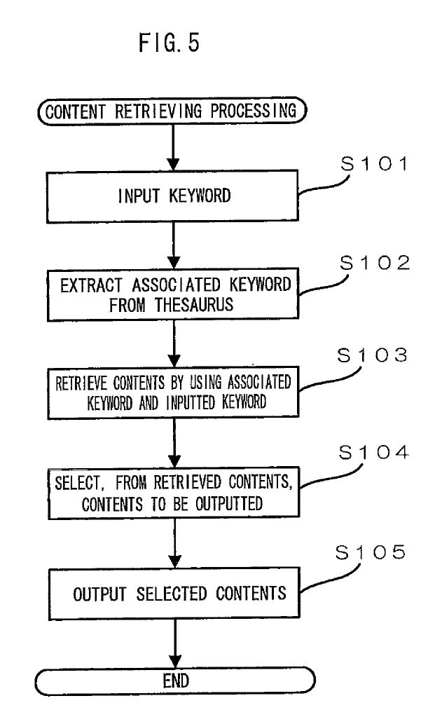

First, content retrieving processing will be described by using FIG. 5. Initially, in step 101, a keyword is inputted by a user through the operation inputting section 65. Note that the keyword that is inputted here is called the inputted keyword in the following description. Further, this inputting is the inputting of a keyword for retrieving contents associated with the keyword. In this case, the keyword may be a single keyword or plural keywords. Further, rather than directly inputting a keyword, one or plural contents that the user selects, or a keyword included in metadata that is annexed to contents, may be used as the keyword inputted here.

In next step 102, associated keyword(s) is/are extracted from the thesaurus. The thesaurus is searched by using the inputted keyword, and associated keywords are listed together with the aforementioned association degrees. The associated keywords that are extracted here may be narrowed down by extracting the keywords whose association degrees are greater than or equal to a predetermined value, or by using, among the listed associated keywords, for example, the 10 or fewer top keywords having the highest association degrees, or the like. Note that the aforementioned association degree table, in which the association degrees that are calculated in advance are stored, may be referred to, or the association degrees may be calculated in step 102.

In this way, in step 102, associated keywords, that are associated with the inputted keyword inputted from the operation inputting section 65, are extracted by using the thesaurus and on the basis of the association degrees that express, by numerical values, the degrees of association between character strings included in the thesaurus.

In subsequent step 103, the one or more associated keywords extracted by the above-described processing, and the contents associated with the inputted keyword, are retrieved from the content table by using the keyword table.

In next step 104, contents to be outputted from the retrieved contents are selected. This is the selection of contents that are to be outputted as the search results from the retrieved plural contents. The two methods that will be described hereinafter can be considered for the method of selection in this case, but the method of selection is not limited to these methods.

The first selection method is a method using the association degrees of the keywords. Specifically, a content is evaluated by the association degree of the inputted keyword that caused that content to be retrieved or by the association degree of the associated keyword, and the contents to be outputted are selected from the standpoint of the top N contents having the highest association degrees or the contents that have association degrees that are greater than or equal to a predetermined level.

Further, in this case, for contents that are retrieved by using plural inputted keywords or associated keywords, the sum of the association degrees of these keywords may be made to be the new, higher association degree thereof.

The other method is a method of selecting a given number of contents from each keyword. Specifically, this is a method of selecting, for each inputted keyword or associated keyword, one or more contents that are retrieved by using the inputted keyword or associated keyword.

Or, a method may be used of selecting, per inputted keyword or associated keyword, plural contents that are retrieved by using the inputted keyword or associated keyword that has a high association degree. Still further, a method may be used of selecting, for each of all of the inputted keywords or associated keywords, one or more contents that are retrieved by using the inputted keywords or associated keywords whose association degrees are greater than or equal to a given value.

When the contents to be outputted are selected in this way, in step 105, the selected contents are outputted to, for example, the display section 64. Other than being outputted to the display section 64, the retrieved contents may be stored as files or a database.

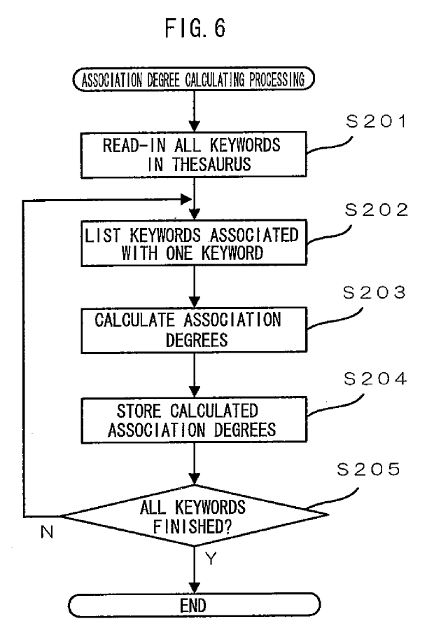

Calculation of the association degree will be described next. As described above, the calculated association degrees are stored in the association degree table. This association degree calculating processing will be described by using FIG. 6.

First, in step 201, all of the keywords in the thesaurus are read-in. This processing is a processing of reading-in, into the RAM 62, the keywords in the thesaurus that is stored in the HDD 63.

In next step 202, the associated keywords that are associated with one keyword are listed. This processing is a processing of searching the thesaurus and listing all of the associated keywords, with respect to one of the keywords that is read-in by the RAM 62.

It is possible for the associated keywords here to be only the directly higher-order, lower-order, and parallel keywords of the associated keywords, or may be keywords that can be arrived at through an arbitrary number of steps within the hierarchical structure of the thesaurus. Using the thesaurus shown in FIG. 3 as an example, the associated keywords that are directly associated with “pork bone soy sauce ramen” are as follows.

Higher-order: “ramen”

Lower-order: “Ramen Yaro”, “ramen shop”

(“Ramen Yaro” is a famous ramen restaurant. Here, “ramen shop” is meant as any ramen restaurant specifically including the character for “shop” (pronounced “ya”) in its name.) Moreover, when expanding the range to words that can be reached through two steps, the following keywords are added in addition to those listed above.

Higher-order: “noodles”

Lower-order: “Yoshiharaya”, “Hakkakuya”, “Chokicei Yaro”, “Maruya”

Parallel: “pork bone ramen”, “soy sauce ramen”, “soybean paste ramen” (“Yoshiharaya”, “Hakkakuya”, “Chokkei Yaro”, “Maruya” are names of ramen restaurants.) After listing the associated keywords in this way, the association degrees are calculated in step 203. This processing is a processing of computing the degree of association with the one keyword explained in step 202, for each of the associated keywords that are listed.

Although there are various methods of computing the association degree, the method used in the present exemplary embodiment is based on the distance (the number of steps) that is a numerical value determined in accordance with vertical relationship information that expresses the vertical relationships between keywords in the thesaurus. Because the distance is determined by the number of steps in this way, the distance is the distance between keywords in the thesaurus. For example, given that the distance between keywords is S, an association degree R is defined by the following formula.

R=int(100/(S+1))

Here, into means that, in the case in which the value within the parentheses is positive, the numbers after the decimal point of this value are omitted so as to make the value an integer. For example, int(4.5) is 4.

Further, as shown by the above formula, if the distance is great, the association degree is small. Namely, the closer the distance, the higher the association degree.

For example, in FIG. 3, the distance S between “ramen shop” and “soy sauce ramen” is 3. Therefore, by applying the above formula, the association degree R is 25.

The method of computing the association degree is not limited to this, and may be any method in which, the greater the distance, the lower the association degree. For example, the association degree may be computed on the basis of the coocurrence relationship between respective keywords, or the like. In this way, in the present exemplary embodiment, a character string that is associated with a character string can be extracted by using the vertical relationship information that expresses relationships between associated character strings. Accordingly, by extracting an associated character string on the basis of association degree information that is expressed by a numerical value determined in accordance with vertical relationship information, a wide range of contents associated with the character string can be retrieved.

In step 204, the association degree that is calculated in this way is recorded in the aforementioned association degree table together with the ID, the keyword, and the associated keyword.

In subsequent step 205, it is judged whether or not the processing of calculating the association degree has finished for all of the keywords. If the processing of calculating the association degree has not finished for all of the keywords, the processing of step 202 is executed for one of the keywords which has not been processed. On the other hand, if processing is finished for all of the keywords, processing ends.

By this processing, the association degrees between character strings included in the thesaurus are calculated in advance. When the association degree is calculated in advance in this way, the association degree prior computation table shown in FIG. 4 is referred to, and if only records that include a keyword with which the keyword coincides are extracted, the associated keywords and the association degrees thereof can be obtained. In this way, the processing of searching the thesaurus and computing the association degree each time a search is carried out is eliminated, and therefore, the processing time needed for retrieval can be greatly shortened.

Reconstructing of the thesaurus will be explained next. As described above, the thesaurus includes vertical relationship information expressing vertical relationships between the keywords that are determined on the basis of the meanings of the keywords. In this case, the thesaurus can be reconstructed by using character string information that includes plural keywords and vertical relationship information expressing vertical relationships between keywords of the plural keywords.

First, the aforementioned character string information (digital dictionary data that is simply called dictionary data hereinafter) will be explained.

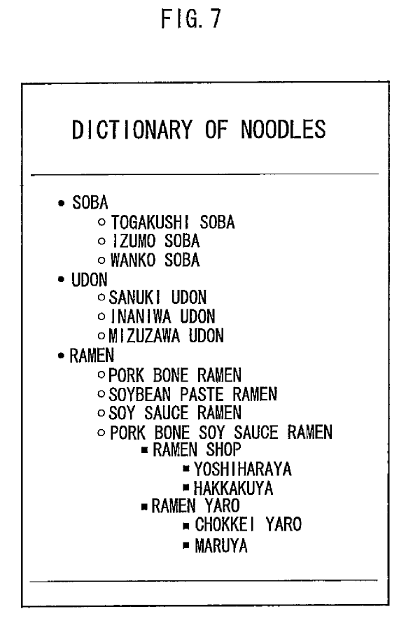

FIG. 7 is an example of dictionary data that is used at the time of thesaurus construction. In this way, data having at least vertical relationships between keywords of the dictionary data is needed. For example, in the example of FIG. 7, “Togakushi soba”, “Izumo soba” and “Wanko soba” (types of specialty soba from different regions in Japan) which are more specific are included among “soba”, and these vertical relationships are used in constructing the thesaurus.

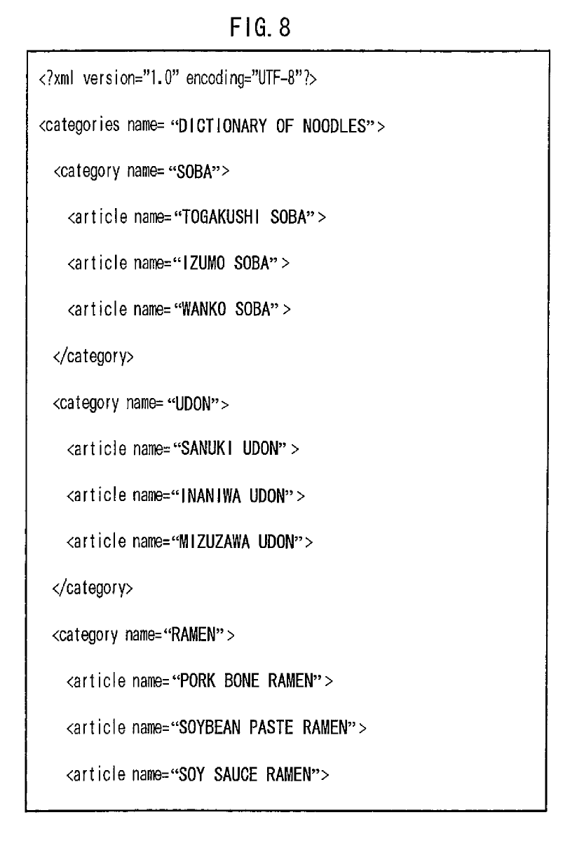

Other than the above-described example of dictionary data, the XML data shown in FIG. 8 also can be used as dictionary data. Three category tags are included under categories that is the route tag shown in FIG. 8, and the name attributes thereof are “soba” (buckwheat noodles), “udon” (thick wheat noodles) and “ramen”. Further, looking at the category tag whose name attribute is “soba”, three article tags are included, and the name attributes thereof are “Togakushi soba”, “Izumo soba” and “Wanko soba”, and these correspond to keywords.

Dictionary data in which the vertical relationships are clear in this way and the hierarchical structure can easily be obtained are preferable. However, the format thereof is not limited to XML, and text data or binary data may be used provided that it is a description format in which the hierarchical structure can be clearly understood. Further, here, the entire hierarchical structure is obtained from one XML data, but the vertical relationships may be described in the respective items of the dictionary data.

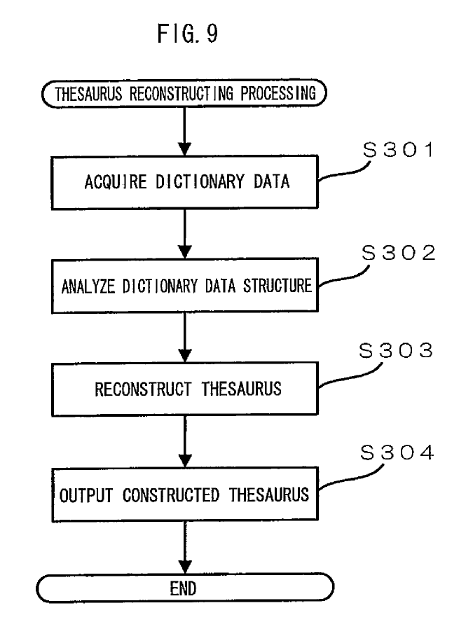

Thesaurus reconstructing processing, which reconstructs a thesaurus from the above-described dictionary data shown in FIG. 8, will be described by using the flowchart of FIG. 9.

First, in step 301, the dictionary data is acquired. The dictionary data may be acquired, for example, from an external device via the aforementioned communication interface 66, or data that is stored in advance in the HDD 63 may be acquired.

In next step 302, the structure of the dictionary data is analyzed. Specifically, the vertical relationships among the respective items in the dictionary data are extracted, and the higher-order/lower-order/parallel relationships among the respective items are determined. For the higher-order/lower-order relationships, if there is already an index of the dictionary data having a hierarchical structure such as shown in FIG. 8, that information may be used as is. Specifically, for example, this is information such as “ramen” is the higher-order concept of “pork bone soy sauce ramen”, and the like.

Further, relationships of inclusion may be deduced by using modifiers from the text information of the dictionary data. For example, in a case in which there is the description “Hakkakuya is a type of ramen shop.” in the item “Hakkakuya” in the dictionary data of FIG. 7, it can be deduced from the modifier that “ramen shop” is the higher-order concept of “Hakkakuya”.

Note that, for the parallel relationships, a method of making keywords having parallel, similar higher-order keywords can be considered. For example, in accordance with the dictionary data of FIG. 7, “Chokkei Yaro” and “Maruya” have the common higher-order keyword “Ramen Yaro”, and therefore, can be considered as being parallel to one another.

The method of analyzing the structure of the dictionary data is not limited to those described above, and, for example, link information between items of the dictionary data, or the like, may be used.

After the structure of the dictionary data is analyzed in this way, in step 303, the thesaurus is automatically reconstructed by reflecting the dictionary data in the thesaurus. Specifically, the thesaurus is constructed on the basis of the higher-order/lower-order/parallel relationships between the respective keywords that are obtained in step 302. Then, in step 304, the constructed thesaurus is stored by, for example, being outputted to the HDD 63.

In this way, the thesaurus that is constructed by using the dictionary data of FIG. 8 is the thesaurus shown in above-described FIG. 3.

In accordance with the above-described processings, a thesaurus can be reconstructed by reflecting dictionary data in the thesaurus. Therefore, the keywords included in the thesaurus can be enriched. Further, a thesaurus can be reconstructed automatically by the above-described processings.

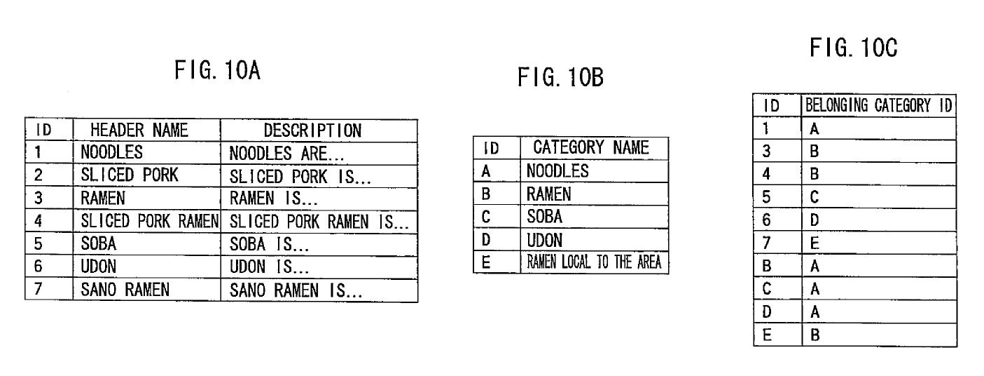

A second method which is different than the above-described thesaurus constructing method (the first method) will be described. First, character string information that includes belonging category information including information, in which respective character strings among plural character strings and the categories to which those character strings belong are set in correspondence, and information, in which the aforementioned categories and categories to which these categories belong are set in correspondence, will be described by using FIG. 10A, FIG. 10B and FIG. 10C. Note that, in the following explanation, each character string of the plural character strings is called a header name.

FIG. 10A shows a header table in which header names and descriptions, that are information relating to the header names, are set in correspondence. As shown in FIG. 10A, the header name “noodles” for example is set in correspondence with the description “Noodles are . . . ”. Further, the ID shown in FIG. 10A is for uniquely identifying the header name and description that are set in correspondence with one another.

FIG. 10B is a category table in which category names and IDs uniquely identifying these category names are set in correspondence. As shown in FIG. 10B, the ID “A” corresponds with “noodles”.

FIG. 10C shows a belonging category table that lists belonging category information including information in which the header names and the categories (belonging category IDs) to which the header names belong are set in correspondence, and information in which these categories and categories (belonging category IDs) to which the categories belong are set in correspondence. In FIG. 10C, these information are expressed by using IDs.

Specifically, in FIG. 10C, for example, the ID “4” represents sliced pork ramen, and the ID “B” represents ramen. Therefore, FIG. 10C shows that sliced pork ramen belongs to the category of ramen. Further, because the ID “C” represents soba and the ID “A” represents noodles, FIG. 10C shows that the category of soba belongs to the category of noodles.

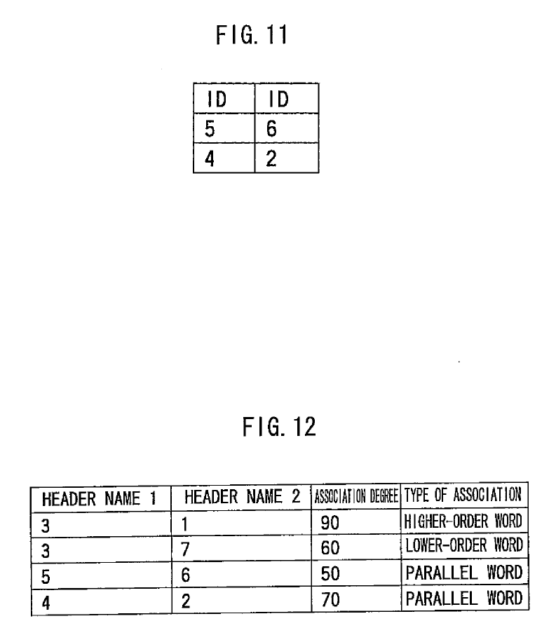

Next, association information in which a fifth character string among the plural character strings is associated from a fourth character string among the plural character strings, will be described by using FIG. 11. In this association information, from the aforementioned header table (see FIG. 10A), the fourth character string is a header name, and a character string, that is included in the description corresponding to that header name, is the fifth character string.

An association table, which is association information in which two IDs are associated with one another, is shown in FIG. 11. Specifically, FIG. 11 shows that the ID “5” (soba) and the ID “6” (udon) are associated, and that the ID “4” (sliced pork ramen) and the ID “2” (sliced pork) are associated. This shows a link in HTML for example, and if “udon” which is mentioned within the description of the header name “soba” is clicked-on, “udon” is displayed.

An association degree table, that shows the association degree and the type of association of two header names, will be explained next by using FIG. 12.

Header name 1, header name 2, association degree, and type of association are shown in FIG. 12. Thereamong, the association degree expresses the association degree of header name 1 and header name 2. The type of association shows which relationship, among a higher-order word, a lower-order word, and a parallel word, header name 2 is in with respect to header name 1. Here, A being a higher-order word of B is used in a case in which A includes B. An example of A and B here is a case in which A is ramen and B is sliced pork ramen, for example. A being a lower-order word of B is used in a case in which B includes A. An example of A and B here is a case in which B is ramen and A is sliced pork ramen, for example. Further, A being a parallel word of B is used in a case in which A is different from both a higher-order word and a lower-order word. An example of A and B here is a case in which A is udon and B is soba, for example.

There are three methods of calculating the association degree here. First, in one calculating method, header name 2, which belongs to a higher-order category that is a category in which belongs the category in which belongs header name 1 which is a character string among plural character strings, is determined from the belonging category table. Further, a category, which belongs to the category in which the header name 2 belongs, is determined from the belonging category table. The association degree is calculated such that, the greater the number of these categories, the more the association degree information between header name 1 and header name 2 decreases.

In a second calculating method, header name 2, which belongs to a lower-order category which is a category which belongs to the category in which belongs header name 1 which is a character string among plural character strings, is determined from the belonging category table. Further, a category, that belongs to the category in which the header name 2 belongs, is determined from the belonging category table. The association degree is calculated such that, the greater the number of these categories, the more the association degree information between header name 1 and header name 2 decreases.

Further, a third calculating method calculates the association degree such that, the greater the number of header names other than header name 2 that are associated with header name 1, the more the association degree information between header name 1 and header name 2 decreases.

The information given in the above-described table is information that is open to the public as a database of a digital encyclopedia on the internet which is dictionary data.

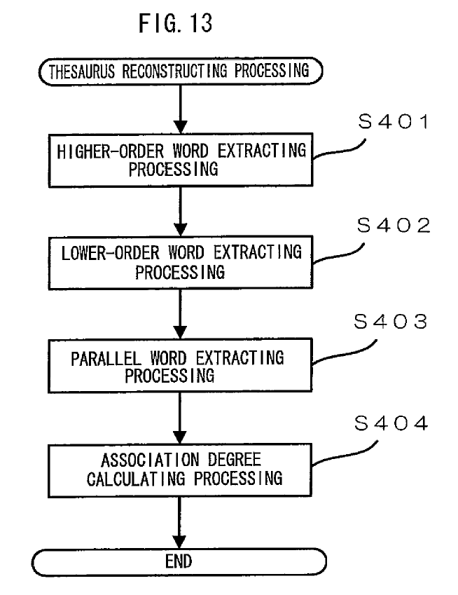

Processing in the second method which is carried out by using the aforementioned table, will be described hereinafter. First, the overall processing of the second method will be described by using the flowchart of FIG. 13.

In step 401, higher-order word extracting processing that extracts the aforementioned higher-order word is carried out. In step 402, lower-order word extracting processing that extracts the aforementioned lower-order word is carried out. In step 403, parallel word extracting processing that extracts the aforementioned parallel word is carried out. Then, in step 404, association degree calculating processing that calculates the aforementioned association degree is carried out.

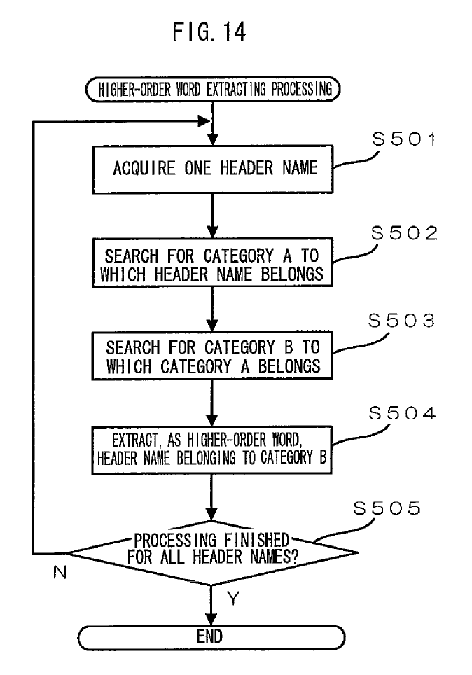

The above steps will be described hereinafter. First, the higher-order word extracting processing of step 401 will be described by using the flowchart of FIG. 14. In initial step 501, one header name is acquired, and in step 502, category A to which the header name belongs is searched for. Then, in step 503, category B, to which category A belongs, is searched for. In step 504, a header name belonging to category B is extracted as a higher-order word. In next step 505, it is judged whether or not processing is finished for all of the header names. If it is not finished, the routine returns to the processing of step 501 again. If it is finished, processing ends.

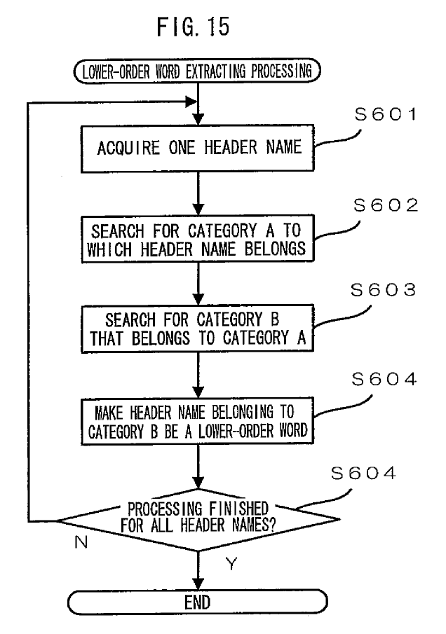

The lower-order word extracting processing of step 402 will be described next by using the flowchart of FIG. 15. First, in step 601, one header name is acquired, and in step 602, category A to which the header name belongs is searched for. Then, in step 603, category B, which belongs to category A, is searched for. In step 604, a header name belonging to category B is extracted as a lower-order word. In next step 605, it is judged whether or not processing is finished for all of the header names. If it is not finished, the routine returns to the processing of step 601 again. If it is finished, processing ends.

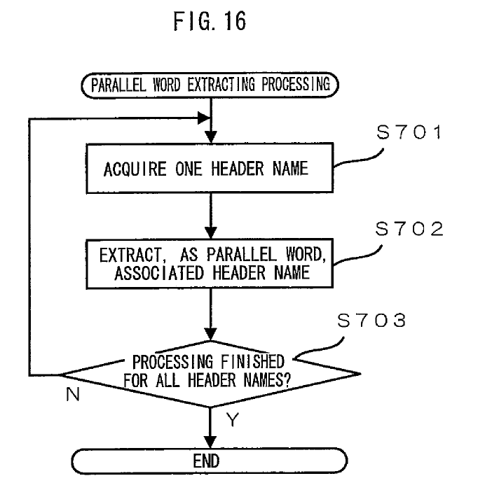

The parallel word extracting processing of step 403 will be described next by using the flowchart of FIG. 16. First, in step 701, one header name is acquired, and in step 702, a header name that is associated is extracted as a parallel word by using the aforementioned association table. Then, in step 703, it is judged whether or not processing is finished for all of the header names. If it is not finished, the routine returns to the processing of step 701 again. If it is finished, processing ends.

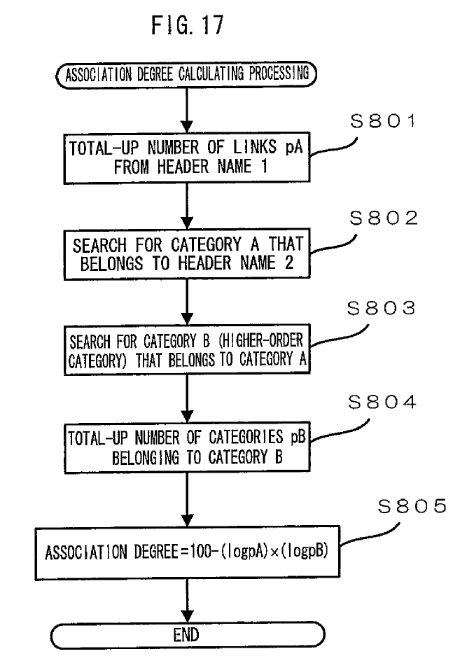

Next, the association degree calculating processing of step 404 will be described by using the flowchart of FIG. 17. First, in step 801, a number of links pA from header name 1 is totaled by using the association table. In next step 80S2, category A that belongs to header name 2 is searched for, and in next step 803, category B that belongs to category A is searched for. In this case, it is made to be the higher-order category. Then, in step 804, a number of categories pB that belong to category B is totaled. In next step 805, the association degree is calculated as 100−(log pA)×(log pB).

As described above, in the present exemplary embodiment, a thesaurus, that is referred to at the time of retrieving associated contents, can be generated itself. Further, because the present exemplary embodiment uses, for example, a digital encyclopedia (dictionary data) on the internet in which the higher-order words/lower-order words/parallel words relationships are clearly obtained, an even more accurate hierarchical structure can be acquired.

In this way, the present exemplary embodiment can provide a content retrieving device that, from dictionary data, can efficiently construct a thesaurus that is used at the time of retrieving content associated with a character string.

The concept of PageRank by Google™ is a method of computing the distance of content that is associated with a similarly inputted keyword. To explain this method basically, the greater the number of links to a page, or the greater the number of links from pages that themselves have great numbers of links thereto, the higher the association degree. In this method, a huge number of eigenvalue vectors must be computed from the link relationships among all of the pages. However, in the present exemplary embodiment, the association degree for a keyword can be computed at a much lower cost because the association degree can be calculated by computing only the numbers of links of keywords in a direct vicinity of the keyword.

The flows of the processings in the respective flowcharts described above are examples. Of course, the order of the processes may be switched, new steps may be added, or unnecessary steps may be deleted, within a scope that does not deviate from the gist of the present invention.

What is claimed is:

1. A content retrieving device comprising:
a content storing unit in which are stored a plurality of contents that are associated with one or more character strings;
a thesaurus storing unit in which is stored a thesaurus that includes vertical relationship information expressing vertical relationships between character strings that are determined on the basis of meanings of the character strings;
an inputting unit by which a character string is inputted;
an extracting unit extracting an associated character string that is associated with an inputted character string inputted by the inputting unit, by using the thesaurus stored by the thesaurus storing unit and on the basis of association degree information that expresses association degrees between character strings included in the thesaurus by numerical values determined in accordance with the vertical relationship information expressing vertical relationships between the character strings; and
a retrieving unit retrieving, from contents that are stored by the content storing unit, contents associated with the associated character string extracted by the extracting unit and the inputted character string.

2. The content retrieving device of claim 1, further comprising a first calculating unit calculating the association degree information on the basis of distances between character strings in the thesaurus,
wherein, when the extracting unit extracts the associated character string, the extracting unit extracts an associated character string whose association degree information calculated in advance by the first calculating unit is greater than or equal to a predetermined value.

3. The content retrieving device of claim 1, father comprising:
an acquiring unit acquiring character string information that includes a plurality of character strings and relationship information expressing relationships between character strings of the plurality of character strings; and
a thesaurus constructing unit that, on the basis of the character string information acquired by the acquiring unit, automatically reconstructs the thesaurus by reflecting the character string information in the thesaurus.

4. The content retrieving device of claim 3, wherein the character string information includes belonging category information that includes information, in which the respective character strings of the plurality of character strings and categories to which the character strings belong are made to correspond to one another, and information, in which the categories and categories to which the categories belong are made to correspond to one another.

5. The content retrieving device of claim 4, wherein the thesaurus constructing unit automatically reconstructs the thesaurus by determining, from the belonging category information, a second character string belonging to a higher-order category which is a category to which belongs a category to which belongs a first character string which is a character string among the plurality of character strings, and making the second character string be a higher-order word of the first character string.

6. The content retrieving device of claim 5, wherein the thesaurus constructing unit automatically reconstructs the thesaurus by determining, from the belonging category information, a third character string that belongs to a lower-order category which is a category that belongs to a category to which the first character string belongs, and making the third character string be a lower-order word of the first character string.

7. The content retrieving device of claim 6, wherein the character string information further includes description information that is information associated with the respective character strings of the plurality of character strings, and association information that, on the basis of description information relating to a fourth character string among the plurality of character strings, associates a fifth character string among the plurality of character strings with the fourth character string, and
the thesaurus constructing unit automatically reconstructs the thesaurus by making the fifth character string, with which the fourth character string is associated in the association information, be a parallel word which is different than both a higher-order word and a lower-order word of the fourth character string.

8. The content retrieving device of claim 7, further comprising a second calculating unit calculating the association degree information on the basis of the thesaurus,
wherein, from the belonging category information, the second calculating unit determines a category belonging to a category to which the second character string belongs, and the second calculating unit carries out calculation such that, the greater the number of the categories, the more the association degree information between the first character string and the second character string decreases.

9. The content retrieving device of claim 7, further comprising a second calculating unit calculating the association degree information on the basis of the thesaurus,
wherein, from the belonging category information, the second calculating unit determines a category belonging to a category to which the third character string belongs, and the second calculating unit carries out calculation such that, the greater the number of the categories, the more the association degree information between the first character string and the third character string decreases.

10. The content retrieving device of claim 7, further comprising a second calculating unit calculating the association degree information on the basis of the thesaurus,
wherein, from the association information, the second calculating unit carries out calculation such that, the greater the number of character strings other than the fifth character string that are associated with the fourth character string, the more the association degree information between the fourth character string and the fifth character string decreases.

11. A content retrieving method comprising:
providing a content storing unit in which are stored a plurality of contents that are associated with one or more character strings;
providing a thesaurus storing unit in which is stored a thesaurus that includes vertical relationship information expressing vertical relationships between character strings that are determined on the basis of meanings of the character strings;
receiving a character string associated with content that is an object of retrieval;
extracting an associated character string that is associated with the character string, by using the thesaurus stored by the thesaurus storing unit and on the basis of association degree information that expresses association degrees between character strings included in the thesaurus by numerical values determined in accordance with the vertical relationship information expressing vertical relationships between the character strings; and
retrieving, from contents that are stored by the content storing unit, contents associated with the extracted associated character string and the inputted character string.

12. The content retrieving method of claim 11, wherein the extracting of the associated character string includes extracting of an associated character string whose association degree information, which is calculated in advance on the basis of a distance between character strings in the thesaurus, is greater than or equal to a predetermined value.

13. The content retrieving method of claim 11, further comprising:
acquiring character string information that includes a plurality of character strings and relationship information expressing relationships between character strings of the plurality of character strings; and
automatically reconstructing the thesaurus by reflecting the character string information in the thesaurus on the basis of the acquired character string information.

14. The content retrieving method of claim 13, wherein the character string information includes belonging category information that includes information, in which the respective character strings of the plurality of character strings and categories to which the character strings belong are made to correspond to one another, and information, in which the categories and categories to which the categories belong are made to correspond to one another.

15. The content retrieving method of claim 14, wherein the reconstructing of the thesaurus includes determining, from the belonging category information, a second character string belonging to a higher-order category which is a category to which belongs a category to which belongs a first character string which is a character string among the plurality of character strings, and making the second character string be a higher-order word of the first character string.

16. The content retrieving method of claim 15, wherein the reconstructing of the thesaurus includes determining, from the belonging category information, a third character string that belongs to a lower-order category which is a category that belongs to a category to which the first character string belongs, and making the third character string be a lower-order word of the first character string.

17. The content retrieving method of claim 16, wherein the character string information further includes description information that is information associated with the respective character strings of the plurality of character strings, and association information that, on the basis of description information relating to a fourth character string among the plurality of character strings, associates a fifth character string among the plurality of character strings with the fourth character string, and
the reconstructing of the thesaurus includes making the fifth character string, with which the fourth character string is associated in the association information, be a parallel word which is different than both a higher-order word and a lower-order word of the fourth character string.

18. The content retrieving method of claim 17, further comprising calculating the association degree information on the basis of the thesaurus, wherein a category belonging to a category to which the second character string belongs is determined from the belonging category information, and the association degree information is calculated such that, the greater the number of the categories, the more the association degree information between the first character string and the second character string decreases.

19. The content retrieving method of claim 17, further comprising calculating the association degree information on the basis of the thesaurus, wherein a category belonging to a category to which the third character string belongs is determined from the belonging category information, and the association degree information is calculated such that, the greater the number of the categories, the more the association degree information between the first character string and the third character string decreases.

20. The content retrieving method of claim 17, further comprising calculating the association degree information on the basis of the thesaurus, wherein the association degree information is calculated from the association information such that, the greater the number of character strings other than the fifth character string that are associated with the fourth character string, the more the association degree information between the fourth character string and the fifth character string decreases.
